(19) United States
(12) Patent Application Publication
(10) Pub. No.: US 2014/0060940 A1
(43) Pub. Date: Mar. 6, 2014

(54) DIGITAL WEIGHT SCALE

(71) Applicants: Selvin G. Barrett, Queens Village, NY (US); Camay S. Barrett, Queens Village, NY (US)

(72) Inventors: Selvin G. Barrett, Queens Village, NY (US); Camay S. Barrett, Queens Village, NY (US)

(21) Appl. No.: 13/602,903

(22) Filed: Sep. 4, 2012

(51) Int. Cl. G01G 19/40

(52) U.S. Cl. 177/25.13

(57) ABSTRACT

Disclosed herein is a scale that includes a main body having a display screen, a user interface, and at least one strap for attaching to a wrist of a wearer. The scale further includes a beam that is attached to the main body and retractable from the main body. The beam extends parallel with the arm of a wearer when the main body is strapped to the wrist of a user. The main body is configured to display the weight of an object that is hanging from the beam on the display screen. Further disclosed herein are embodiments of scales that are attachable to mobile communicators.

### FIELD OF TECHNOLOGY

The subject matter disclosed herein relates generally to a digital weight scale. More particularly, the subject matter relates to a digital weight scale providing a compact lightweight, wrist-worn digital electronic scale, designed to weigh, and display in either English (pounds) or Metric (grams/kilograms) units, quickly and accurately the weight of articles held or lifted by the hand and arm on which the scale is worn.

### BACKGROUND

Digital electronic scales have been around for some time and are found in bathrooms of most households. But, in dozens of situations many people wish that they could weigh something, but have no means for doing so. For example, a household bathroom scale is generally not available if one is fishing and catches a big fish, or if one is packing a carry-on bag in a hotel room and wants to know whether it will be charged extra, or if one is wondering whether one has overloaded household trash bags.

Thus, an wrist-worn digital weight scale, and method of use thereof, would be well received in the art.

### SUMMARY

According to a first described aspect, a scale comprises: a main body having a display screen, a user interface, and at least one strap for attaching to a wrist of a wearer; and a beam that is attached to the main body and retractable from the main body, wherein the beam extends parallel with the arm of a wearer when the main body is strapped to the wrist of a user; wherein the main body is configured to display the weight of an object that is hanging from the beam on the display screen.

According to a second described aspect, an attachment for a mobile communicator comprises: a main body; a data carrying element configured to carry data from the main body and attachable to a data port of the mobile communicator; a weighing chord extending from the main body; and a hook attached to an end of the weighing chord; wherein the main body is configured to communicate with the mobile communicator such that the mobile communicator displays, on a display screen of the mobile communicator, the weight of an object that is hanging from the main body on the hook when a person is holding the main body.

According to a third described aspect, an attachment for a mobile communicator comprises: a main body attachable to a data port of the mobile communicator, the main body configured to directly or indirectly hold the weight of an object; wherein the main body is configured to communicate with the mobile communicator such that the mobile communicator displays, on a display screen of the mobile communicator, the weight of an object that is hanging from the main body when a person is holding the main body.

### BRIEF DESCRIPTION OF THE DRAWINGS

The subject matter disclosed herein is distinctly claimed in the claims at the conclusion of the specification. The foregoing and other features and advantages are apparent from the following detailed description taken in conjunction with the accompanying drawings in which:

FIG. 1 depicts a perspective view of a digital weight scale according to one embodiment;

FIG. 2 depicts a perspective view of the digital weight scale of FIG. 1 in use;

FIG. 3 depicts a perspective view of the digital weight scale of FIGS. 1 and 2 in use in another manner;

FIG. 4 depicts a perspective view of another digital weight scale attached to a mobile communicator according to one embodiment; and

FIG. 5 depicts a perspective view of another digital weight scale attached to a mobile communicator in accordance with yet another embodiment.

### DETAILED DESCRIPTION

A detailed description of the hereinafter described embodiments of the disclosed apparatus and method are presented herein by way of exemplification and not limitation with reference to the Figures.

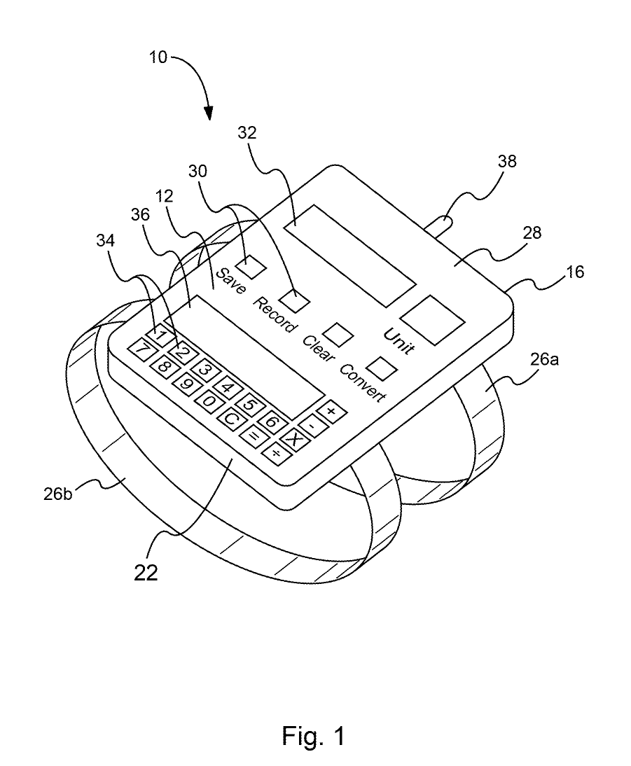

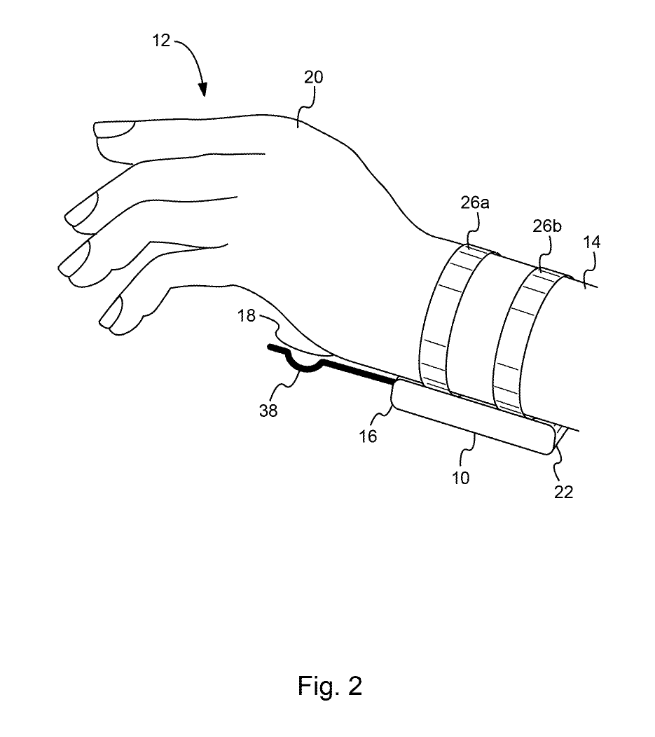

As illustrated in FIGS. 1 and 2, a scale 10 is shown having a main body 11. The scale 10 may be a digital weight scale that provides a compact, lightweight, wrist-worn digital electronic scale, designed to weigh, and display in either English (pounds) or Metric (grams/kilograms) units, quickly and accurately the weight of articles held or lifted by the hand and arm on which the scale 10 is worn.

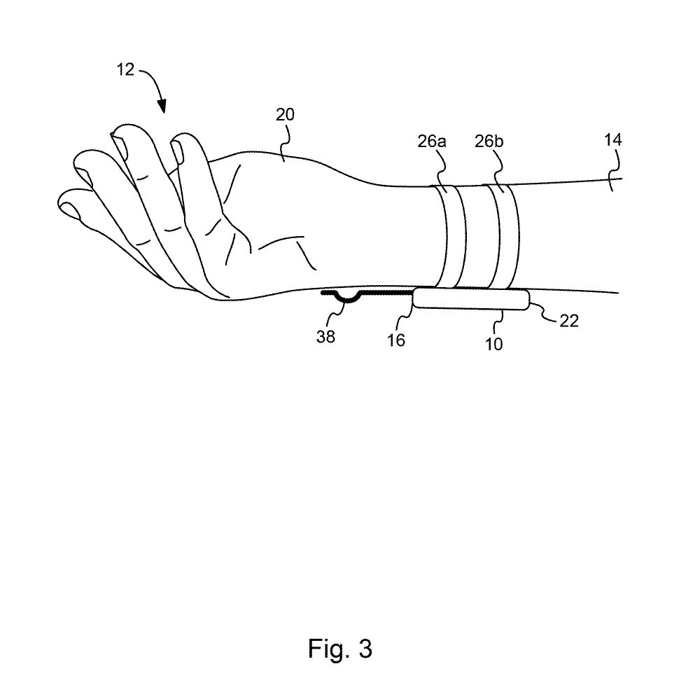

The scale 10 may be rectangular in shape, approximately four inches in length by two inches in width, and one and one half inches in thickness or depth. The scale 10 is not limited to these dimensions, however, and may be either larger or smaller, depending on the embodiment. As shown in FIGS. 1-2, the scale 10 may be worn by a wearer 12 lengthwise over a forearm 14, with its distal end 16 at a heel 18 of a hand 20 and its proximal end 22 extending back toward an elbow (not shown) of the wearer. Alternately, as shown in FIG. 3, the scale 10 may be worn by the wearer 12 on an underside of the forearm 14 in a similar manner. Whatever orientation the scale 10 is worn, two adjustable wristbands 26a, 26b may be equipped to secure the scale in place with a concave, lengthwise contour on an underside of the scale 10. The adjustable wristbands 26a, 26b may be attached to each other with a buckle or hook and loop fasteners to ensure an adjustable, comfortable fit.

The scale 10 may include a face 28 that includes control and function buttons 30, as well an LCD screen 32 or windows. The controls 30 may enable the wearer to turn the scale 10 on or off, as well as to clear its memory, save the weight of a weighed object, and convert from pounds to kilograms or vice versa. A calculator 34 with a numeric pad and functions and, in one embodiment, its own LCD screen 36, may be incorporated into the scale 10. It should be understood that the LCD screens 32, 36 may be any appropriate digital display for displaying at least numbers, and potentially letters and other symbols.

A lever, bar, or hook 38 may extend from the distal end 16 of the scale 10 to extend out midway over the hand 20 of the wearer, with the lever acting as the balance beam of the scale 10. The lever, bar, or hook 38 may be telescopic or retractable in one embodiment. For example, prior to weighing an object, the wearer may extend the lever 38, clear the memory of the scale, and set the scale to a neutral setting. The scale 10 then takes this position as zero. In the case that a cantilever beam 38 is used to measure the weight of the object, the scale 10 may include an integrated gyroscope (not shown) in order to ensure that the scale 10 is being held at a perfectly parallel plane to the ground. This may help to ensure the accuracy of the cantilevered measurement by ensuring that the object to be weighed hangs at a perfectly perpendicular angle from the cantilever beam 38. In the case that the scale 10 needs to be moved in order for the cantilever beam 38 to be perpendicular to the hanging object, the LCD screen 32 may display a message notifying the user to hold the scale 10 parallel with the ground.

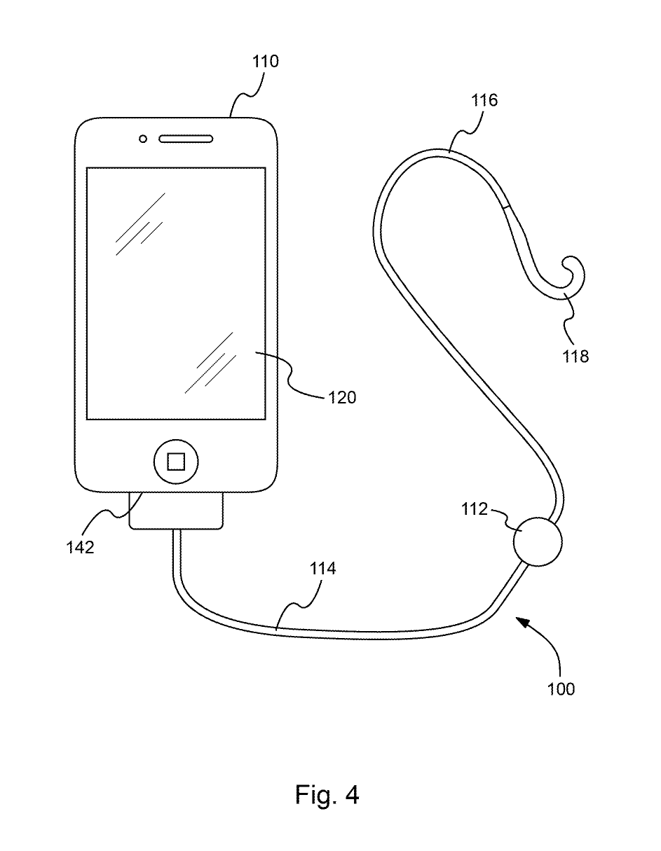

Alternately, the scale 10 may have an internal computer processor that is in communication with both the cantilever beam 38 and the integrated gyroscope. This may allow the scale to be capable of calculating the weight of the object no matter what angle the user is holding the scale 10 at during the weighing. The computer may thus account for any movement or angles during the weighing. This may be accomplished by taking the stresses on the cantilever beam 38 over time, and matching those stresses with the exact angle that the cantilever beam is being held at. Furthermore, the cantilever beam 38 may have a touch sensor that determines at which point on the cantilever beam 38 the object is being held at. For example, the object may be close to the main body 11, or farther from the main body 11. Additionally, the beam 38 may include a U-shaped curved portion, as shown in FIG. 4, that would allow the handle of the object to be weighed to always settle at a low point. This embodiment may prevent the need for the above-described touch sensor.

To weigh the object, the wearer may hold the scale with their palm up in the embodiment shown in FIGS. 1-2, and palm down in the embodiment shown in FIG. 3. The wearer may then hang the handle of the object (in the case that the object is luggage), or some other appropriate portion of the object from the beam, lever, or hook 38. In one embodiment, the wearer may press a button for the scale 10 to calculate the weight. In another embodiment, the weight is calculated automatically. The object's weight is then determined and displayed, and the wearer can either save this measurement for comparison with the weights of other objects, convert this measurement from English to Metric and vice versa, or clear the scale's memory of this object. After use, the wearer may retract the lever, beam or hook 38 back into the main body 11 of the scale 10.

The main body 11 of the scale 10 may be made of a tough, durable impact and scratch resistant material. The material may, for example, be an injection molded thermoplastic. The casing may include a secure compartment for a power supply (not shown) for powering the digital and computerized components of the scale 10. The battery portion may be similar to a watch battery. Alternately, the scale 10 may include a rechargeable battery that may include a charger for charging with a typical outlet.

Worn on the wrist and instantly accessible for determining the weight of a variety of objects including trash bags, fish, buckets of paint, luggage, cuts of meat, or the like. The scale 10 may give a wide range of users an accurate weight scale for use in the field, at home, or anywhere that weighing is needed. The potential markets for the scale includes but is not limited to homeowners, airline travelers, commercial and recreational fisherman, workers in the food processing industries, hunters and the like.

In another embodiment shown in FIG. 4, a scale 100 is shown as an attachment to a data port 142 of a mobile communicator 110. The mobile communicator 110 may be any type of typical device carried by a person everyday such as a smart phone (Iphone (R), Android (R), Blackberry (R)), tablet (Ipad), or the like. The scale 100 may include a main body portion 112 that is attachable to the data port 142 of the mobile communicator 110 via a data carrying wire 114. It should be understood that the data carrying wire 114 may be eliminated in this embodiment if the main body portion 112 is directly connected to the data port 142 of the mobile communicator. The main body portion 112 may include memory, or a computer processor, or the like, which may be in communication with the mobile communicator 110 via the data carrying wire 114.

Extending from the main body portion 112 may be another cord 116 at the end of which a hook 118 is attached. The cord 116 and hook 118 combination may be used for weighing. In use, a person can attach the object for weighing to the hook 118 and hold the mobile communicator 110 in one hand, and the main body portion 112 in another. The memory and processor of the main body portion 112 may analyze the input provided by the cord 116 regarding the weight of the object and provide this information to the mobile communicator 110 for being displayed by a display 120 of the mobile communicator 110.

In one embodiment, the mobile communicator 110 may be able to download an application that integrates with the scale 100 attachments. In another embodiment, the scale 100 may include memory, as described hereinabove, and may be configured integrate with the operating system of the mobile communicator 110 such that the scale 100 automatically loads an appropriate application into the mobile communicator 110 upon being plugged into the mobile communicator 110 to allow the mobile communicator 110 to receive and display the weight information.

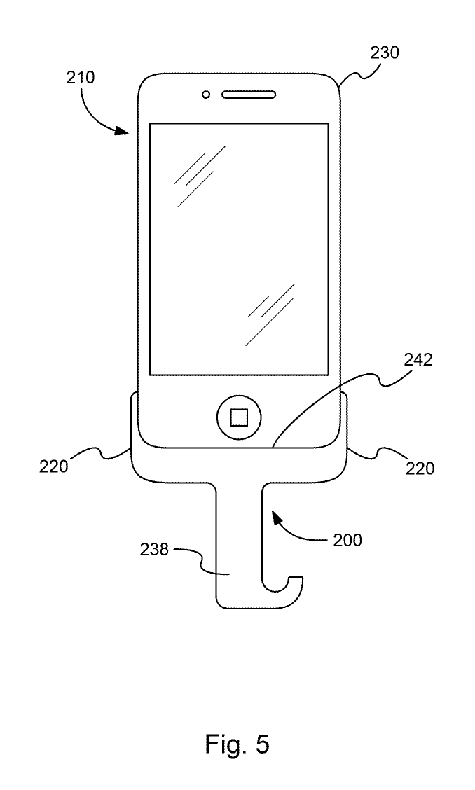

In yet another embodiment shown in FIG. 5, a single attachment scale 200 is shown attached to another mobile communicator 210 similar to the mobile communicator 110. This embodiment may be similar to the first embodiment shown in FIGS. 1-3. However, in this embodiment, the mobile communicator 210 replaces the main body 11. Furthermore, rather than having an extendable or telescopic beam 38, the present embodiment includes a beam 238 having a u-shaped portion 240 that attaches to the mobile communicator 210. The single attachment scale 200 may be connected directly to a data port 242 of the mobile communicator 210. The single attachment scale 200 may also include a housing portion 220 that integrates with an outer housing portion 230 of the mobile communicator 210. In particular, the housing portion 220 may be configured to be attached to the mobile communicator 210 at the same place as a protective case otherwise would be. In other words, a user may remove a portion of a protective case of the mobile communicator 210 in order to attach the single attachment scale 200 to the mobile communicator 210. By attaching the single attachment scale 200 in this way, the object may be weighed by the single attachment scale 200 without putting stress on the data port 242.

In this embodiment, it should be understood that the mobile communicator 200 may be able to download an application that integrates with the scale 200 attachment, similar to the scale attachment 200 described hereinabove. Alternately, the scale 200 may include memory and may be configured integrate with the operating system of the mobile communicator 210 such that the scale 200 automatically loads an appropriate application into the mobile communicator 210 upon being plugged into the mobile communicator 210 to allow the mobile communicator 210 to receive and display the weight information. It should further be understood that the mobile communicator 200 may already include an integrated gyroscope. The application for the mobile communicator 210 may interact with this integrated gyroscope in order to determine the orientation of the mobile communicator as described hereinabove with respect to FIGS. 1-3 in order to achieve an accurate weight calculation.

In still another embodiment, blue tooth or other wireless technology may be utilized so that the scale 100, 200 is not directly connected to the mobile communicator 100, 200. Rather, the weight of the object may be sent wirelessly to the mobile communicator from the scale 100, 200.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

I claim:

1. A scale comprising:
a main body having a display screen, a user interface, and at least one strap for attaching to a wrist of a wearer; and
a beam that is attached to the main body and retractable from the main body, wherein the hook extends parallel with the arm of a wearer when the main body is strapped to the wrist of a user;
wherein the main body is configured to display the weight of an object that is hanging from the hook on the display screen.

2. The scale of claim 1, wherein the beam includes a U-shaped portion such that the hanging object settle at a lowpoint in the U-shaped portion.

3. The scale of claim 1, wherein the main body includes two adjustable straps such that the main body may be worn either above the wrist or on an underside of the wrist.

4. The scale of claim 1, wherein the main body includes a second display screen that includes a calculator.

5. The scale of claim 1, wherein the main body includes an integrated gyroscope configured to determine the orientation of the main body and the beam.

6. The scale of claim 1, wherein the main body is configured to display a command to a wearer to hold the beam and the main body in a parallel orientation to the ground.

7. The scale of claim 1, wherein the object is selected from the group consisting of luggage, a fish, meat, a trash bag, and a can of paint.

8. An attachment for a mobile communicator comprising:
a main body;
a data carrying element configured to carry data from the main body and attachable to a data port of the mobile communicator;
a weighing chord extending from the main body; and
a hook attached to an end of the weighing chord;
wherein the main body is configured to communicate with the mobile communicator such that the mobile communicator displays, on a display screen of the mobile communicator, the weight of an object that is hanging from the main body on the hook when a person is holding the main body.

9. The attachment for the mobile communicator of claim 8, wherein the object is selected from the group consisting of luggage, a fish, meat, a trash bag, and a can of paint.

10. The attachment for the mobile communicator of claim 8, wherein the data carrying element is a data carrying wire.

11. The attachment for the mobile communicator of claim 8, wherein the main body is configured to automatically load an application into the memory of the mobile communicator that allows for interaction with the main body when the main body is attached to the data port of the mobile communicator.

12. The attachment for the mobile communicator of claim 8, wherein the main body is configured to communicate with the mobile communicator after the mobile communicator downloads an application.

13. The attachment for the mobile communicator of claim 8, wherein the main body includes a computer processor and memory.

14. An attachment for a mobile communicator comprising:
a main body attachable to a data port of the mobile communicator, the main body configured to at least one of directly and indirectly hold the weight of an object;
wherein the main body is configured to communicate with the mobile communicator such that the mobile communicator displays, on a display screen of the mobile communicator, the weight of an object that is hanging from the main body when a person is holding the main body.

15. The attachment for a mobile communicator of claim 14, wherein the object is selected from the group consisting of luggage, a fish, meat, a trash bag, and a can of paint.

16. The attachment for the mobile communicator of claim 14, wherein the main body is configured to wirelessly communicate with the mobile communicator.

17. The attachment for the mobile communicator of claim 14, wherein the main body is configured to communicate with the mobile communicator after the mobile communicator downloads an application.

18. The attachment for the mobile communicator of claim 14, wherein the main body is configured to automatically load an application into the memory of the mobile communicator that allows for interaction with the main body when the main body is attached to the data port of the mobile communicator.

19. The attachment for the mobile communicator of claim 14, wherein the main body attaches to the mobile communicator at a place where a protective case would be attached, and wherein the attachment of the main body to this place prevents stress on the data port when the object is being hung from the main body.

20. The attachment for the mobile communicator of claim 14, wherein the main body includes a beam having a U-shaped portion such that the hanging object settle at a low point in the U-shaped portion when being hung from the main body.
